(19) United States
(12) Patent Application Publication
(10) Pub. No.: US 2015/0346102 A1
(43) Pub. Date: Dec. 3, 2015

(54) Compact Raman Probe Integrated with Wavelength Stabilized Diode Laser Source

(71) Applicant: Innovative Photonic Solutions, Inc., Monmouth Junction, NJ (US)

(72) Inventors: Robert V. Chimenti, Runnemede, NJ (US); Scott L. Rudder, Hopewell, NJ (US); Harald R. Guenther, Schnecksvile, PA (US); Joseph B. Gannon, Howell, NJ (US); John C. Connolly, Clarksburg, NJ (US)

(73) Assignee: INNOVATIVE PHOTONIC SOLUTIONS, INC., Monmouth Junction, NJ (US)

(21) Appl. No.: 14/614,862

(22) Filed: Feb. 5, 2015

Related U.S. Application Data
(60) Provisional application No. 62/007,314, filed on Jun. 3, 2014.

(51) Int. Cl. G01N 21/65

(52) U.S. Cl. CPC G01N 21/65; G01N 2201/06113; G01N 2201/0636

(57) ABSTRACT

A compact Raman probe integrated with a wavelength-stabilized laser source is disclosed. The output beam of the laser source has an elongated cross-section that is focused onto a target of interest. Raman and Rayleigh scattered light is collected, collimated, and filtered by free-space optics to form a beam that is coupled to the input of a multimode optical fiber having an elongated core that is aligned to edge slits of an optical spectrometer.

### FIELD OF THE INVENTION

This invention relates to the field of spectroscopy and more particularly to a Raman spectroscopy probe.

### BACKGROUND OF THE INVENTION

Raman spectroscopy is a well-known spectroscopic technique that can be used to observe vibrational, rotational, and other low-frequency modes in molecules. Raman scattering is an inelastic process whereby monochromatic light, typically provided by a laser, interacts with molecular vibrations, phonons, or other excitations, resulting in the energy of the laser photons being shifted up or down. Due to conservation of energy, the emitted photon gains or loses energy equal to energy of the vibrational state. FIG. 1 is a schematic energy-level diagram of down-shifted (Stokes) Raman scattering, 130, and up-shifted (Anti-Stokes) Raman scattering, 140. In the case of Stokes scattering, 130, an optical pump, 131, excited a transition from the ground state, 110, of the probed molecule to a virtual state, labeled as 121 in the figure, which is not a real excited state of the molecule. A corresponding photon, 132, is emitted when the molecule relaxes down to a real state and may be detected. In the case of Anti-Stokes Raman scattering, 130, a pump photon, 141, excites the molecule from one of its excited states, shown in the figure as 111, to a virtual state, shown as 122. A corresponding photon, 142, is emitted when the molecule relaxes to the ground state and may be detected.

The wavelength of the optical pumping line, 131 or 141, in FIG. 1 above, also called the pumping line, will also generate elastically backscattered Rayleigh scattered photons when incident on a target material at the same photon energy as the laser line. Note that all optical pump beams used in Raman spectroscopy to excite an appropriate target will give rise to a strong Rayleigh backscattered line, a weak Stokes signal, and a weaker anti-Stokes signal.

The strength of a Stokes or Anti-Stokes signal is proportional polarization amplitude as a function of frequency, P(ω) of a dielectric medium. As is well-known in the art:

P(ω)∝χᵣ⁽³⁾(ω)Eₚ²Eₛ (1)

where χᵣ⁽³⁾(ω) is the non-linear Raman coefficient and is itself frequency dependent, Eₚ is the pump laser field amplitude, and Eₛ is the Stokes or Anti-Stokes electric field amplitude. [See, e.g., Handbook of Biomedical Nonlinear Optical Microscopy, Barry R. and Peter So, Oxford University Press, 2008, p. 171, eq. 7.18.] Because the Raman signal strength depends on the square of the pump field amplitude, i.e., Eₚ², it is therefore proportional to the optical intensity of that laser pump. Because the Raman signal depends on pump power so significantly, and because, as is known in the art, the number of Raman signal photons generated is of the order of 10⁻⁷ of the pump photons, it is important to collect as many Raman signal photons as possible in order to generate a detected signal having adequate signal-to-noise.

Diode lasers are the most commonly used light sources in Raman spectroscopy. FIGS. 2A and 2B schematically illustrates diode lasers, 201 and 202, configured to emit in a single-spatial mode and multiple-spatial modes, respectively. The active regions of both devices are illustrated by the lines 211 and 212, respectively. The output of these devices is shown as the spatial beam profiles at the output facets, 221 and 222, respectively. The near-field output beam profile, 221, of the single-spatial mode laser, 201, is schematically illustrated as being a well-filled spot; in fact, it has a smoothly varying intensity profile. The near-field output beam profile, 222, of the multiple-spatial mode laser, 202, is shown as being an irregularly filled spot of longer extent in the direction parallel to the epitaxial layers.

The output of diode lasers having sufficient power density to excite Raman scattering is typically generated from a region approximately 1 μm (in the direction perpendicular to the planes of epitaxial growth of the semiconductor laser material) but which is wider in the orthogonal direction (parallel to the planes of epitaxial growth of the semiconductor laser material). This width may be in the range of 3 μm (for single-spatial mode lasers) to 100 μm or more (for multi-spatial mode lasers). Higher power pump lasers are desirable in Raman spectroscopy as they result in increased Raman signal. Thus, broad-area or wide-stripe multiple-spatial mode lasers are often preferred. The typical shape of the pump light from such a laser when imaged onto a target of interest is elongated. In the perpendicular direction, this shape may be Gaussian-like. In the parallel direction, the image of the near field of the laser may comprise a Gaussian-like profile for a single-spatial mode laser or an irregular profile for a multi-spectral mode laser. Thus, the illuminated region of the target may be described as having an elongated shape, such as an ellipse or a line, with a ratio of long dimension to short dimension that may vary from approximately 3:1 to greater than 100:1.

While both single-spatial mode and multiple-spatial mode lasers may be used to excite Raman scattering, multiple-mode (“multimode”) lasers typically provide greater optical power and will be used herein as an exemplary embodiment, without limiting applicability of this disclosure to use of single-mode lasers.

FIG. 3 schematically illustrates contours of pump laser excitation intensity on a target under investigation by Raman spectroscopy. The intensity mapping, 300, comprises contours of constant optical pump intensity, increasing as shown schematically by contours 301, 302, 303, 304, and 305, all falling within an elongated area, exemplified in the figure by rectangle 310. Alternatively, the elongated area may be approximated by an ellipse, a super-ellipse, or any other regular or irregular elongated shape having a major axis greater than a minor axis.

While the Raman signal is proportional to the intensity of excitation optical power at the target, that intensity must be maintained below a level at which the target substance will not be subject to thermal degradation. In many cases, the long dimension of the pump laser light pattern on the target, approximately the horizontal length of the exemplary rectangle, 310, is of the order of 100 μm to several times that length, the details determined by the extent of the pump laser output beam on a lens that focusses the pump light onto the target and the focal length and numerical aperture of that focusing target lens.

Raman spectroscopy is typically practiced by exciting target molecules using laser light, collecting the scattered light, which includes both Rayleigh and Raman scattered components as well as fluorescent emission, filtering out the non-Raman scattered signal as much as possible, and analyzing the received light using a spectrometer.

Scattered light may be collected by the same lens used to direct excitation light towards the target. Because the number of Raman scattered photons is inherently many orders of magnitude less than the number of laser pump photons, capturing as many Raman signal photons as possible is necessary in order to generate a Raman spectrum with sufficient signal-to-noise to allow both detection of molecular species of interest with both high sensitivity and high selectivity in practical systems. Thus, Raman probes may be configured to use the target lens as a signal collection lens, as well, and direct the collected signal photons towards the entrance aperture of an optical path to a spectrometer.

Spectrometers designed for Raman spectroscopy are commercially available. Typically, these apparatuses comprise a slit through which received light passes, one or more optical elements (e.g., concave mirrors) to collimate the received light and reflect it so that the received light illuminates a wide area of a diffraction grating or other wavelength-dispersive element. The light from the wavelength-dispersive element is then collected and collimated by additional optics (e.g., a concave mirror) and directed towards an array of detector elements. The detector array may, for example, be a linear array. Because of its position and width, each element of the detector array will detect a relatively narrow band of wavelengths of light, with the center wavelength of each element of the linear array.

The resolution of a grating spectrometer is determined, in part, by the width of its entrance slit, the number of grating lines illuminated, and the spacing of elements in its detector array.

A practical issue that arises with the use of linear detector arrays is that light exiting from the optics of a Raman probe must be aligned with the optical elements of the spectrometer to maximize the amount of light that falls on each detector element. Light rays entering through the spectrometer slit at an angle to the normal of the slit may fall above or below detector elements in a linear array. One means of improving the proportion of light that is detected is to position an anamorphic optical element, such as a positive cylindrical lens that redirects light rays that would otherwise miss a detector element to hit that element. Another approach is the use of a two-dimensional detector array, wherein additional detector elements above and below the nominal axis that are illuminated with those light rays that would otherwise escape detection.

In the case of light transmitted to the slit of spectrometer via a fiber optic cable, the core of that fiber optic could, in principle, function as the entrance slit to the spectrometer. In practice, however, slight tilts of the fiber optic cable with respect to the normal to spectrometer's input optical axis or translations of the core from the nominally optimum position can reduce the amount of light received by the detector elements or impart inaccuracies in the determined spectrum.

In practice, therefore, a convenient means of ensuring the correct position of light entering the spectrometer is by use of a slit, formed by two edges spaced apart by typically 25 to 75 μm in the direction in which light is dispersed within the grating by the dispersive element. The length of the slit opening in the perpendicular direction is typically several to many times greater.

One approach, well-known in the art, is to use a multimode fiber optic to receive light from the lens and direct it towards the spectrometer. The core of such multimode optical fibers is typically of the order of 200 μm in diameter, sized to collect as much of the scattered light as possible from the illuminated target area, 300.

FIG. 4 shows that use of such a multimode fiber substantially overfills the open aperture of a spectrometer slit, 491, formed by two straight-edges, 492 and 493, respectively, spaced apart by a distance W, the clear aperture of the slit. This slit is shown in a vertical orientation in this exemplary presentation, but could be oriented at any angle. The output of a circular core multimode fiber, which is positioned proximate to the slit, 491, is shown as the circle 410 having a core diameter, D_{CORE}.

The core of multimode circular fiber of FIG. 4 is surrounded by a cladding region of lower refractive index, the cladding region having a diameter of D_{CLAD}, but the thickness of the clad does not affect the amount of light entering the slit. In common usage of prior art, D_{CORE} is of the order of 200 μm and, therefore, typically overfills the clear aperture of the slit, 401, which is typically in the 25 to 75 μm range, allowing only light falling in the region, 430, of FIG. 4, to enter the spectrometer. As is evident from this example, a significant fraction of the Raman signal light is thereby blocked and is unavailable for detection.

The long edges of the two straight-edges, 492 and 493, respectively, which form the clear aperture, 491, may be made substantially longer than the width of the clear aperture, W. This has been recognized and used in prior art to allow transmission of scattered light from the target to the spectrometer via fiber optic bundles. In such cases, a plurality of relatively narrow circular core optical fibers is configured in a bundle, with the input end approximating the size and shape of the scattered light beam collected by a lens from a target under investigation. The individual fibers of the bundle are position in a way to allow their output ends to align with proximate to the clear aperture of the slit, 491, while only slightly overfilling slit 491.

FIG. 5 illustrates the input end of an exemplary “round-to-slit” fiber optic bundle configuration. In this exemplary illustration, seven identical multicore optical fibers, 511, 521, 531, 541, 551, 561, and 571, having core diameter D_{CORE} and clad diameter D_{CLAD}, are shown in a hexagonal packing configuration, such that the area from which they can receive light approximates the size and shape of the scattered light beam collected by the target lens, 590. Also shown is an exemplary clad region, 512. None of the light incident upon the facet of such clad regions will propagate to the output end of the fibers. As an example, light incident on clad region 524 adjacent to core 521 will not be transmitted to the output end of that fiber. Also, interstitial regions, empty space between the outer extents of the cladding regions of the individual fibers, 526, will not contribute to the light received at the spectrometer slit. As such, a substantial portion of the scattered signal light, potentially available for detection and analysis in a spectrometer, is lost.

FIG. 6 is an adaption of prior art described by B&W Tek on their website (bwtek.com/spectrometer-part-7-fiber-optic-bundles), illustrating this type of common bundled fiber optic assembly, called a “round to slit” configuration.

In this figure, only three output fibers are shown, having cores 611, 621, and 623, with respective cladding regions, 612, 622, and 632. As described with respect to FIG. 5, light in cladding regions, such as 624 and 635, is not transmitted to the entrance aperture of the spectrometer, 691. The width of the core of each multimode fiber, D_{CORE}, is typically slightly larger than the width of the clear aperture of the slit, W for reasons described below.

What is needed is an optical system that efficiently transmits scattered light collected from a target under investigation to the entrance slit of a spectrometer, which is also robust with respect to small deviations from the nominal angle and position of the input light to the spectrometer.

Also needed is a compact Raman probe in which a wavelength-stabilized pump laser source is integrated.

### SUMMARY OF THE INVENTION

A compact Raman probe comprising an integrated wavelength-stabilized laser source is disclosed, the probe being compatible with many commercially available fiber optic spectrometers. This integrated Raman probe provides users with the capability of acquiring Raman spectroscopic data of the highest quality in a low cost.

The compact Raman probe includes optics to configure the output beam of the laser source to have an elliptical cross-section, approximating the shape of the elongated emission region of the laser near-field, rather than a circular cross-section. The elliptical cross-section laser beam is transmitted to a target under investigation and the resultant scattered signal light is transmitted by the compact Raman probe via an optical beam that has a corresponding elliptical cross-section. An optical fiber incorporating a core having a substantially elongated cross-section, with dimensions approximating that of the elliptical cross-section of the returned scattered light beam, transmits the returned scattered light to the entrance aperture of a spectrometer. Such an entrance aperture is typically formed by a slit having a narrow opening, designed to vignette the fiber in order to increase the system's spectral resolution, in the direction parallel to the direction is which light is dispersed within the spectrometer and a longer opening in the direction perpendicular to that in which light is dispersed within an appropriately designed spectrometer. The longer opening allows an increase in the optical signal entering and, therefore, received by the sensor elements within such a spectrometer. Use of a substantially elongated cross-section optical fiber to deliver the scattered light received by the compact Raman probe to the spectrometer thereby enables improved matching of the image of the emitting area on the target of interest and the entrance aperture of the spectrometer. This improvement in detection efficiency is a factor of greater than currently achievable using circular cross-section excitation and detection optical beams.

An advantageous feature of the compact Raman probe is usage of a free-space optical excitation path within the housing of the probe rather than one in which the internal optics comprises, at least in part, optical fibers to transmit excitation light to the target of interest, as is known in the art (see, e.g., U.S. Pat. No. 5,112,127). Raman probes having one or more optical fiber transmission paths often must use fiber optic connectors to couple the scattered light into the probe, resulting in loss of optical signal due to both the connector itself and coupling of the laser source to an internal optical fiber that transmits the excitation light. As a result, the excitation laser used in such Raman probes must either be operated at higher current to maintain the required optical power at the target or the detected Raman signal will suffer power losses. Incorporation of a free space excitation path enables reliable delivery of high power at the target while operating the laser at a lower drive current than typical of Raman systems of prior art, reducing power consumption by the laser and increasing its useful lifetime.

In an embodiment of the Raman probe, an external cavity laser (ECL) is the integrated wavelength-stabilized laser source.

In an embodiment, the Raman probe incorporates diode laser drive and temperature-stabilization electronics within the probe housing. See, for example, U.S. Ser. No. 13/957,586, “Wavelength-Stabilized Diode Laser” published as USAPP 2014/0072004 A1, the contents of which are incorporated by reference, herein.

In other embodiment of the compact Raman probe, a distributed Bragg reflector (DBR) or distributed feedback (DFB) is the wavelength-stabilized laser source.

In other embodiments of the compact Raman probe, the light emitted by the integrated laser may be used as the pump source for a non-linear optical (NLO) conversion to produce a different wavelength, e.g., by second-harmonic generation (SHG), third-harmonic generation (THG), or any other non-linear optical process.

In another embodiment, an elongated cross-section optical fiber is integrated with the probe housing.

In another embodiment, the power at which the laser is operated is controllable by a user via an input on the probe housing.

### BRIEF DESCRIPTION OF DRAWINGS

For a better understanding of exemplary embodiments and to show how the same may be carried into effect, reference is made to the accompanying drawings. It is stressed that the particulars shown are by way of example only and for purposes of illustrative discussion of the preferred embodiments of the present disclosure, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates the principles of Stokes and Anti-Stokes Raman scattering.

FIG. 2A illustrates a single-spatial mode diode laser

FIG. 2B illustrates a multiple-spatial mode diode laser.

FIG. 3 illustrates the near-field of a multimode laser imaged onto a target from which Raman signals may be detected.

FIG. 4: illustrates an entrance slit of a spectrometer of width W illuminated by the output of a multimode optical fiber having a core diameter D.

FIG. 5 schematically illustrates an exemplary input end of a “round-to-slit” fiber optic bundle.

FIG. 6 schematically illustrates the output end of a “round-to-slit” fiber optic bundle of prior art.

FIG. 7 illustrates a block diagram of an exemplary embodiment of the Raman probe incorporating a wavelength-stabilized laser source according to the principles of the invention, in which the laser light is reflected by a dichroic mirror.

FIG. 8 illustrates a block diagram of an exemplary of the Raman probe incorporating a wavelength-stabilized laser source according to the principles of the invention, in which the laser light is transmitted through a dichroic mirror.

FIG. 9 illustrates a block diagram of an exemplary embodiment of the Raman probe incorporating a wavelength-stabilized laser source according to the principles of the invention, in which the laser light is reflected by a dichroic mirror.

FIG. 10 illustrates a block diagram of an exemplary embodiment of the Raman probe incorporating a wavelength-stabilized laser source, in which the laser light is reflected by a dichroic mirror.

FIG. 11 illustrates a cross-sectional view of an optical fiber having a rectangular core.

FIG. 12 illustrates a cross-sectional view of an optical fiber having an elliptical core.

It is to be understood that the figures and descriptions of the present invention described herein have been simplified to illustrate the elements that are relevant for a clear understanding of the present invention, while eliminating, for purposes of clarity many other elements. However, because these omitted elements are well-known in the art, and because they do not facilitate a better understanding of the present invention, a discussion of such elements is not provided herein. The disclosure herein is directed to also variations and modifications known to those skilled in the art.

### DETAILED DESCRIPTION

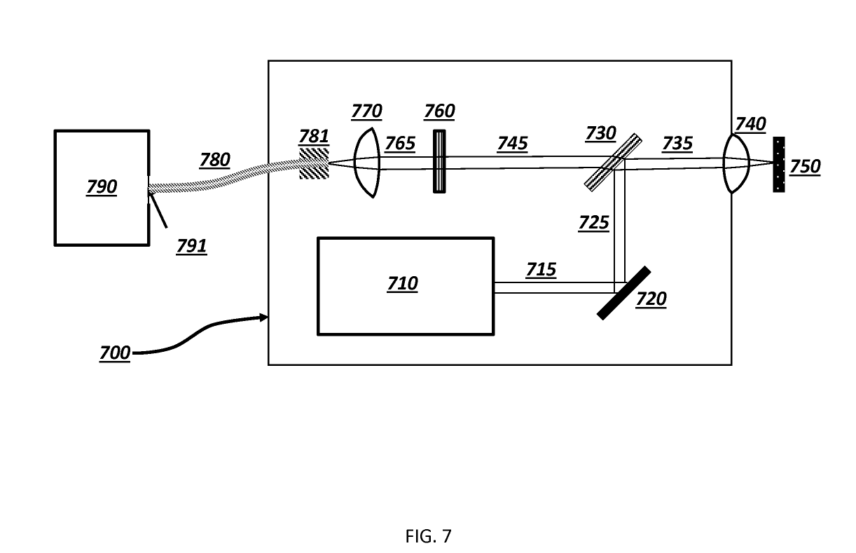

FIG. 7 illustrates the optical layout in an embodiment of the Raman probe in a housing, 700, incorporating a wavelength-stabilized laser source, 710. The laser may emit light in a single spatial mode or multiple spatial modes.

The wavelength-stabilized laser source, 710, may be any laser device or system. The oscillation wavelength may be any wavelength at which the gain medium can operate. For example, semiconductor diode lasers are currently commercially available in the range of about 340 nm to about 11 μm and these short- and long-wavelength limits are likely to be extended as the technology improves.

One class of lasers that may be used as the wavelength-stabilized laser source, 710, is an external cavity laser. See, for example, U.S. patent application Ser. Nos. 13/957,585 and 14/094,790, the contents of which are incorporated, in their entirety, by reference, herein.

The wavelength-stabilized laser source, 710, may also be semiconductor lasers that incorporate gratings within their structure, such as a distributed feedback (DFB) or distributed Bragg reflector (DBR) laser, as is well-known in the art.

The wavelength-stabilized laser source, 710, may also be a DFB or DBR laser coupled to a non-linear optical element for second- or third-harmonic generation of shorter wavelength laser light, as is well-known in the art.

In all cases, an amplified spontaneous emission (ASE) filter (not shown in the figures) is provided to filter the output, 715, of the wavelength-stabilize laser source, 710, in order to substantially eliminate amplified spontaneous emission light that would otherwise swamp the Raman signal to be detected.

The compact Raman probe includes optics to configure the output beam of the laser source, portions of which being designated 715, 725, and 735 in FIG. 7, to have an elliptical cross-section, which is transmitted towards the target, 750. Scattered signal light is transmitted through the compact Raman probe via an optical beam, portions of which being designated 735, 745, and 765 in FIG. 7, which has a corresponding elliptical cross-section. The elliptical or elongated cross-section of the optical beams is chosen to enhance the amount of signal light that enters a spectrometer, 790, through its entrance slit, 791. The entrance slit, 791, is usually set to have a width that is typically in the range of about 20 μm to about 75 μm. A key advantage of this invention is that the elliptical cross-section beam enables a greater amount of signal light to be dispersed and detected in the spectrometer, 790, than would a circular cross-section beam.

In the embodiment shown, the output light of the laser source 710, which emits the pump light wavelength, is reflected at an angle by a mirror, 720, towards a dichroic mirror, 730, via an optical beam, 725. The dichroic mirror, 730, reflects the light in a beam, 735, to a lens, 740, that focuses the light onto a target, 750, as a probe to excite Raman scattering. Light emitted by a single spatial mode laser source may be focused to a small spot, as small as the diffraction limit, at the target, 750, achieving high power-density. Such high-brightness excitation spots are often preferred for samples having good uniformity, e.g., liquids. Alternatively, light emanating from a multiple spatial mode laser, which may allow higher output power than would a single spatial mode laser, may be spread over a larger area at the target, 750, and, therefore, may result in a higher collection of Raman signal as compared with a lower power single spatial mode laser configuration. Larger probe areas are often used to probe relatively non-uniform samples, where the molecule of interest may be dispersed in a host medium and/or the target has a rough surface resulting in additional scattering of potential Raman signal light.

The pump light of the probe beam, 735, gives rise to Rayleigh scattering as well as Raman scattering, as is well-known in the art. Photons arising from the Rayleigh and Raman effects scatter with an angular dependence. Only a portion of the scattered light is, therefore, collected by the target lens, 740, which creates a beam that counter-propagates along path 735 to the dichroic mirror, 730. Mirror, 730, is selected to transmit a large portion of the scattered light having a wavelength that has been shifted from the wavelength of the pump light by the Raman effect. The target lens, 740, may be integrated with or separated from the housing, 700.

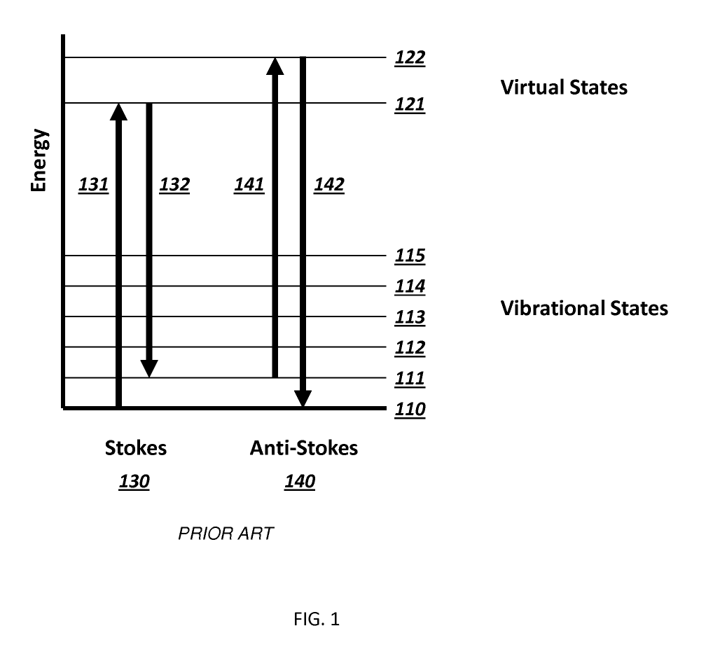

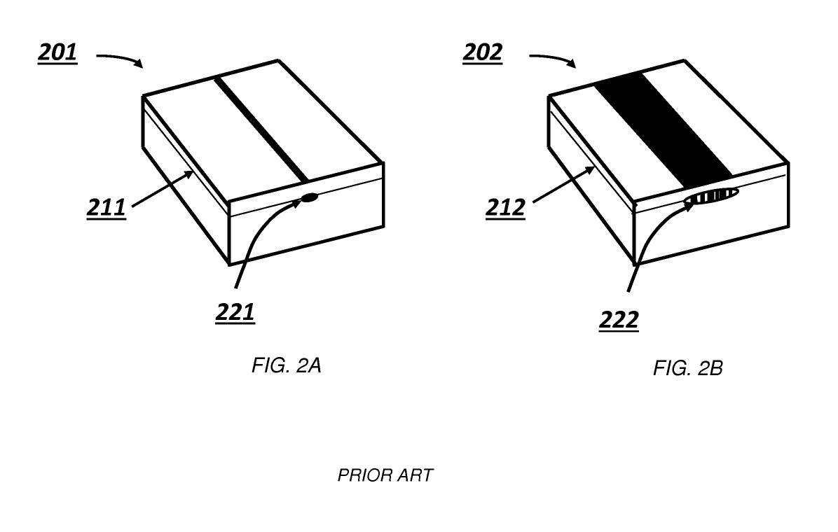

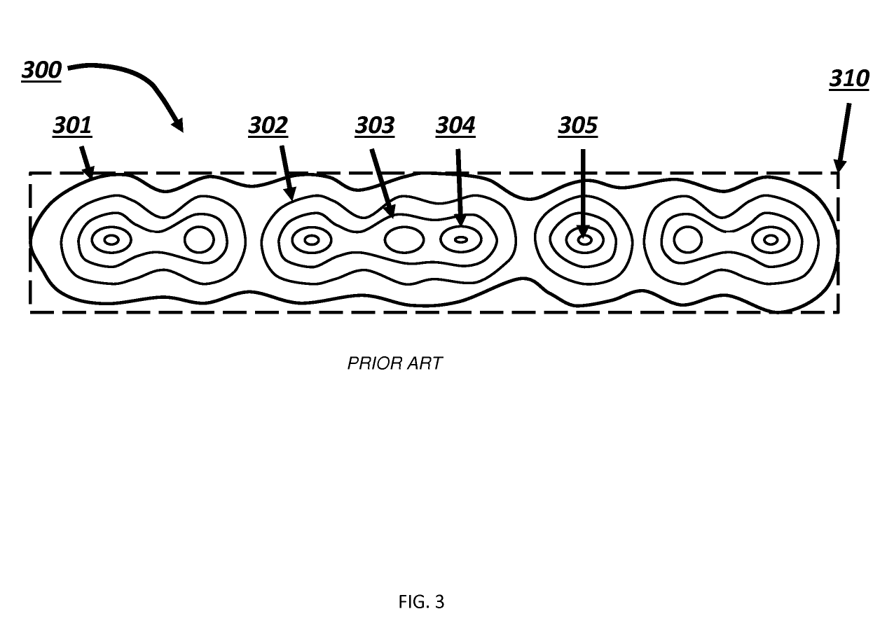

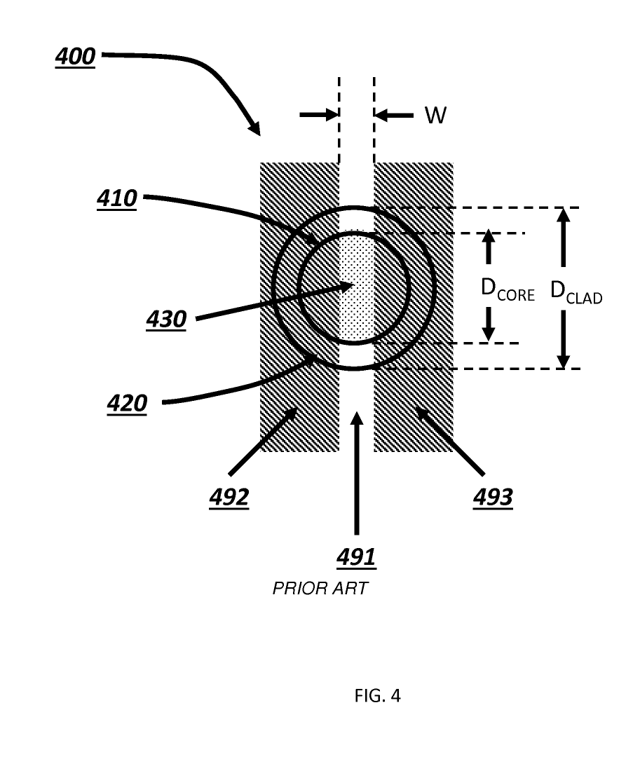

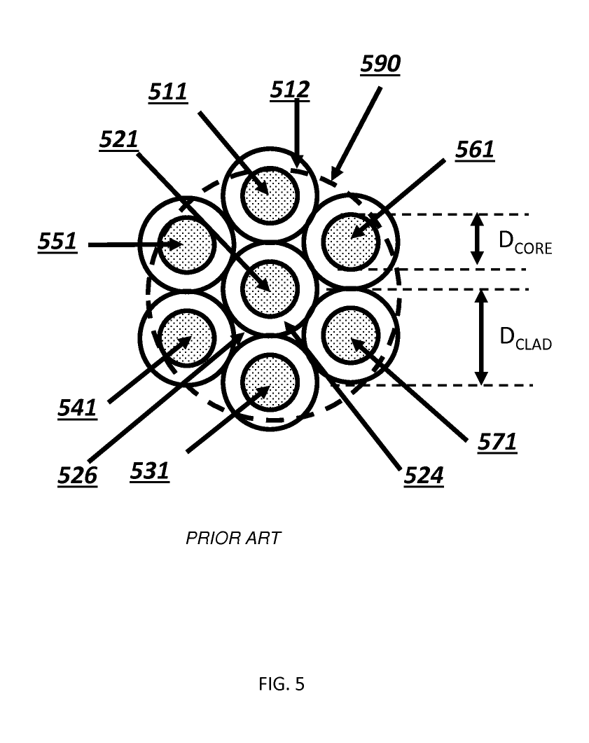

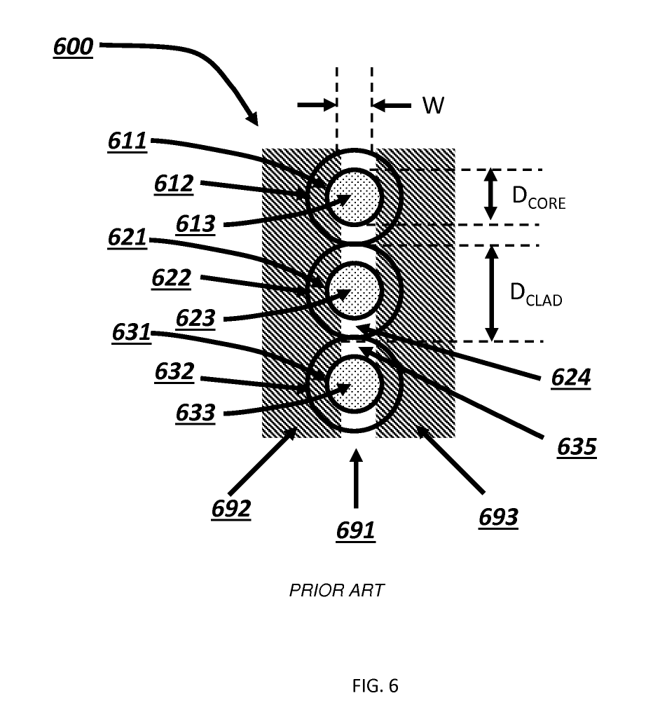

Referring again to FIG. 1, the pump light beam, 131, from the laser source may excite both Stokes and Anti-Stokes emission wavelengths. The Stokes signal, 132, has an energy that is less than that of the energy of the photons of the pump light beam 131 outputted from laser source, 131, whereas the Anti-Stokes signal, 142, has an energy that is greater than that of the corresponding photons, 141 of the pump light beam 131. Thus, the Stokes signal, 132, is at a longer wavelength than the wavelength of the pump laser light, 131, while the Anti-Stokes signal, 142, is at a shorter wavelength than the wavelength of the pump laser light, 141.

The strength of an Anti-Stokes signal depends on the population density of molecules existing in the upper excited state, e.g., 111, of FIG. 1, giving rise to the Anti-Stokes photons. The population density of excited states of molecules is typically described by the Boltzmann distribution, which describes the probability of a molecule being in an excited state as proportional to e^{-E/kT}, where E is the energy of the excited state and T is temperature. Since, under normal thermal equilibrium conditions, the population of the exemplary excited state, 111, is less than the population of the ground state, 110, the Stokes signal, 132, is typically stronger than the Anti-Stokes signal, 142,

Returning to FIG. 7, the dichroic mirror, 730, may be an edge filter that is designed to preferentially transmit wavelengths of the scattered light while preferentially removing wavelengths other than near the pump wavelength. In an embodiment of a system in which the Stokes signal wavelength, 132, is to be detected, the dichroic mirror, 730, preferentially removes wavelengths longer than that of the pump wavelength 715. In an embodiment of a system in which the anti-Stokes wavelength, 142, is to be detected, the dichroic mirror, 730, preferentially removes wavelengths shorter than that of the pump wavelength 715 In another embodiment, the dichroic mirror is a notch filter that blocks the laser wavelength while transmitting both Stokes and Anti-Stokes signals.

The dichroic mirror, 730, is typically used at a 45° angle of incidence and, in the embodiment shown in FIG. 7, reflects the pump laser light 715, 725 towards the target under investigation, 750. An exemplary dichroic mirror is Semrock's RAZOREDGE Dichroic™ laser-flat beamsplitter, which, in an exemplary product designed for use at 785 nm, reflects greater than 98% of incident s-polarized 785 nm light while transmitting greater than 93% of light at wavelengths longer than approximately 803 nm. Alternatively, the dichroic mirror, 730, may be a notch filter of which Semrock's 45° multiedge BRIGHTLINE® filter is an example.

In the embodiment illustrated in FIG. 7, the signal beam, 745, that is transmitted through dichroic mirror 730 propagates as a free-space optical beam, and is incident on a filter, 760, which may be an edge-filter or a notch filter, to preferentially reduce optical transmission of any specularly reflected pump light and Rayleigh scattered light that passes through the dichroic mirror at the pump light wavelength. In embodiments in which the Stokes signal is to be detected and the filter, 760 is an edge filter, wavelengths shorter than the pump wavelength are preferentially removed. In embodiments in which the anti-Stokes signal is to be detected and the filter, 760, is an edge filter, wavelengths longer than the pump wavelength are preferentially removed. Elimination of as much of the pump light and Rayleigh light as is possible improves the signal-to-noise of the detected Raman signal. Thus, an optical density (OD) of 6 or greater (i.e., a factor of 10⁶) is desirable and achievable by current commercial products. Exemplary filters include STOPLINE® single notch filters, and RAZOREDGE® ultrasteep long-pass edge filters and ultrasteep short-pass edge filter provided by Semrock. The filter, 760, may be chosen to transmit light at wavenumbers that differ from that of the laser line (or wavelength) by as little as 5 cm⁻¹ to over 4,000 cm⁻¹. For example, filter 760 may comprise a notch filter that blocks specific non-desired wavelengths (e.g., Raman wavelength) or a high pass filter that blocks specific non-desired wavelengths (i.e., wavelengths shorter than the Raman wavelength) or a low pass filter that blocks specific non-desired wavelengths (i.e., wavelengths greater than the Raman wavelength).

An overall optical density at the pump laser wavelength of OD≧8 (a factor of 10⁸) provided by the combination of the dichroic mirror, 730, and filter, 760, is desirable.

The filter, 760, may be a dichroic filter, a volume holographic grating filter, a fiber Bragg grating filter used in combination with focusing and collection optics, or any filter that provides the required wavelength-dependent blocking and transmitting capabilities.

After passing through filter 760, the filtered free-space beam, 765, continues to propagate to a focusing optic, shown as lens 770 in FIG. 7. The lens, 770, focuses the light of the filtered free-space optical beam, 765, onto one end of an optical fiber, 780, which has an elongated core. The optical fiber, 780 is positioned so that the end of its elongated core proximate to the lens, 770, is aligned parallel to the long axis of the illuminated region of the target, 750. Similarly, the elongated core proximate to the lens 770 is aligned parallel to the long axis of the light propagating through lens 770.

In one aspect of the invention, means for aligning the elongated core proximate lens 770 may incorporate a microscopic adjustment mechanism that alters the position of the elongated core up and down, side to side and angularly, with respect to the shape of the light exiting lens 770.

The optical fiber, 780, transmits the Raman signal light to the entrance slit, 791, of a spectrometer, 790. The entrance slit, 791, may be fixed or adjustable in width. Slit widths in the range of 20-75 μm are typically used. FIG. 7 illustrates an embodiment in which the optical fiber, 780, is held by a fixture or coupling, 781, within the Raman probe housing, 700.

The optical fiber, 780, is aligned such that its core is substantially collinear with the filtered free-space optical beam, 765. The long dimension of the elongated cross-section optical fiber, 780, is oriented angularly to substantially coincide with the long axis of the focused beam waist formed by the focusing optic, 770, acting on the filtered free-space optical beam, 765. This translational and angular orientation may be effected, for example, by use of micromanipulators or other means. Although not shown, it would be recognized that the micromanipulators, for example, may be incorporated into coupling 781. Thus, coupling 781 provides the means for coupling or retaining as first end of fiber 780 and to position the first end of fiber 780 to align the core of fiber 780 to receive a maximum amount of light transmitted through lens 770.

The output of the elongated cross-section optical fiber, 780, must be such that the long dimension of the elongated core is parallel to the long dimension of the opening in the spectrometer slit, 791. This alignment can be effected in several ways, including but not limited to rotating the spectrometer with respect to the output beam pattern from the fiber optic or by mechanically twisting the fiber optic cable.

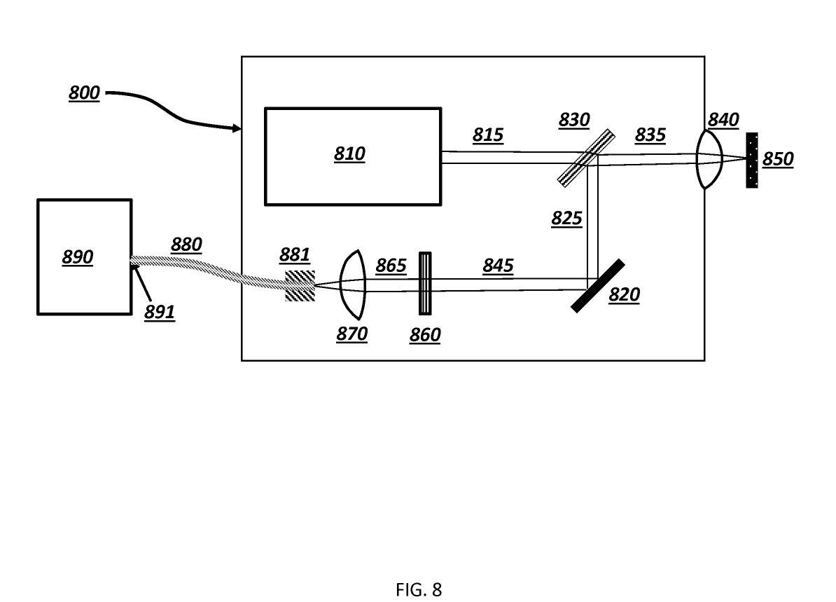

FIG. 8 illustrates an embodiment of the Raman probe in the output of the laser source, 810, is transmitted through dichroic mirror 830 via an optical paths 815 and 835 to lens 840, which focuses the light onto a target, 850, to excite Raman scattering. Raman and Rayleigh scattered light is collected by the lens, 840, and collimated into counter-propagating beam 835 towards the dichroic mirror, 830, which preferentially reflects the Raman and Rayleigh scattered light towards a mirror, 820, via a free-space optical path, 825. The light reflected from the mirror continues to propagate in a free-space path, 845, to a filter, 860. For detection of the Stokes signal, filter, 860, preferentially removes wavelengths shorter than the pump wavelength. For detection of the Anti-Stokes signal, filter, 860, preferentially removes wavelengths longer than the pump wavelength. A notch filter may be used to remove the pump laser wavelength and the Raman wavelength, while allowing detection of the Stokes and/or Anti-Stokes signal. In addition, the detected light is transmitted to a spectrometer slit 891 via an elongated cross-section optical fiber 880, in a manner similar to that described with regard to FIG. 7. The orientation of the elongated cross section optical fiber 880 is similar to that described with regard to FIG. 7.

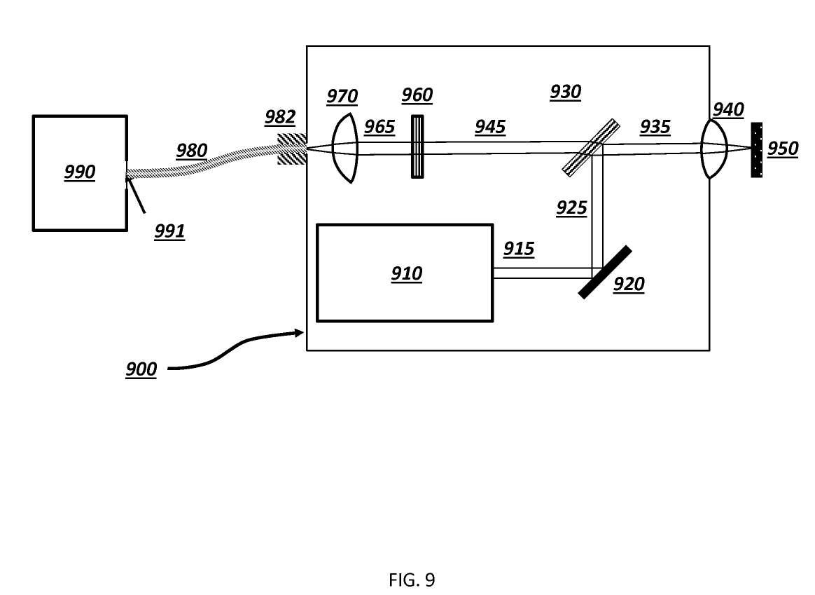

FIG. 9 illustrates an embodiment, based on the exemplary configuration shown in FIG. 7, wherein the elongated core optical fiber 980 is attached by a fixture or coupling. 982, to the housing, 900, of the Raman probe. The embodiment of the invention shown in FIG. 9 operates in a manner similar to that described with regard to FIG. 7. Thus, the description of the operation of the embodiment shown in FIG. 7 is applicable in describing the operation of the embodiment shown in FIG. 9. Accordingly, one skilled in the art would understand and appreciate the operation of the configuration shown in FIG. 9 from reading the description of the embodiment shown in FIG. 7.

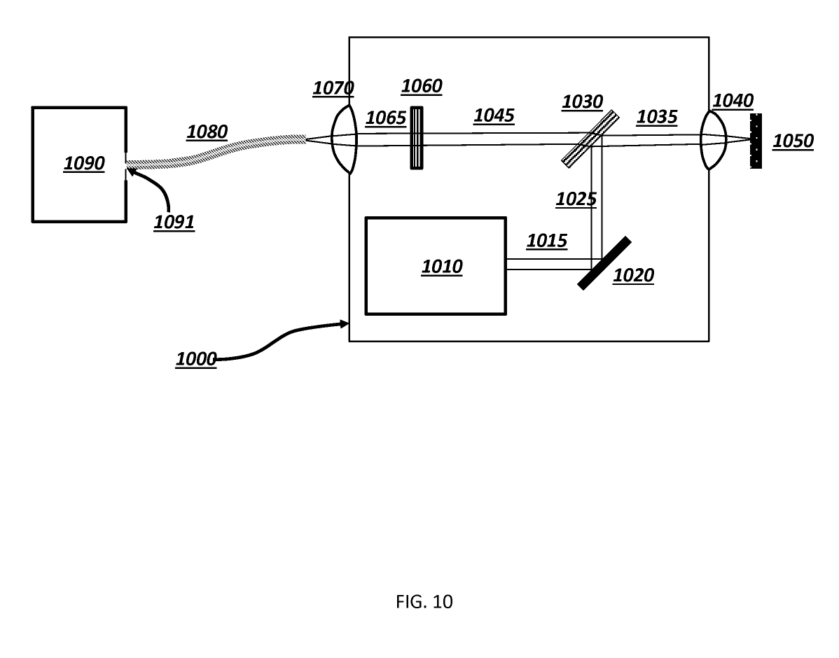

In the embodiment of FIG. 10, an elongated core optical fiber, 1080, is positioned apart from the housing, 1000, of the Raman probe. Lens 1070 focuses signal light from the Raman probe so that it enters the core of the optical fiber, 1080.

The elongated core optical fiber, 1080, may be integrated with or separated from the compact Raman probe housing, 1000.

The embodiment of the invention shown in FIG. 10 operates in a manner similar to that described with regard to FIG. 7. Thus, the description of the operation of the embodiment shown in FIG. 7 is applicable in describing the operation of the embodiment shown in FIG. 10. Accordingly, one skilled in the art would understand and appreciate the operation of the configuration shown in FIG. 9 from reading the description of the embodiment shown in FIG. 7.

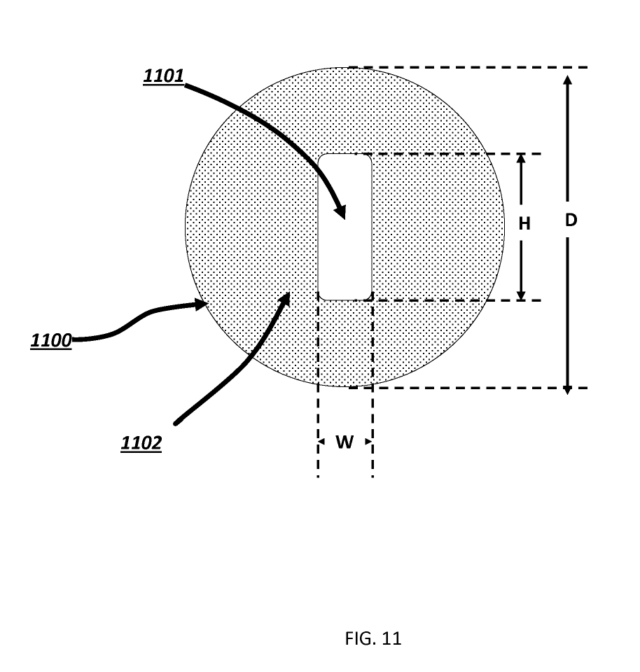

FIG. 11 is a cross-sectional view of optical fiber, 1100 having a substantially rectangular core, 1101, surrounded by a clad region, 1102. Such fibers are commercially available, e.g., from Ceramoptek, for example. As with conventional optical fibers, the core, 1101, has a higher refractive index than does the clad, 1102, thereby transmitting trapped light in the core, 1101, by total internal reflection and defining the numerical aperture (NA) of the fiber, as is well-known in the art, wherein NA={n_{core}²−n_{clad}²}^{1/2}, where n_{core} and n_{clad} are, respectively, the refractive index of the core and the clad.

In accordance with the principles of the invention, and referring again to FIG. 7, the NA of the fiber 780 may be matched to the NA of the focusing optic, 770, for efficient coupling of light from the filtered free-space optical beam, 765, into the optical fiber, 780.

As shown, the core, 1101, of the optical fiber, 1100, has a width, W, and a height, H, such that the ratio, H/W, typically ranges from 2 to 6. Exemplary configurations of heights and widths are 150×75 μm, 120×50 μm, and 100×25 μm. The width, W, of the core may be approximately equal to or larger than the spectrometer slit, 791 of FIG. 7. The cladding region of the fiber, 1102, is shown having a diameter, D, which may be any size that is sufficiently large compared to the optical field propagating in the core, 1101, so that optical losses are negligible. The cladding region may itself be comprised of more than one region and may be coated with buffer layers or protective layers and also be encased in one or more jackets for further protection.

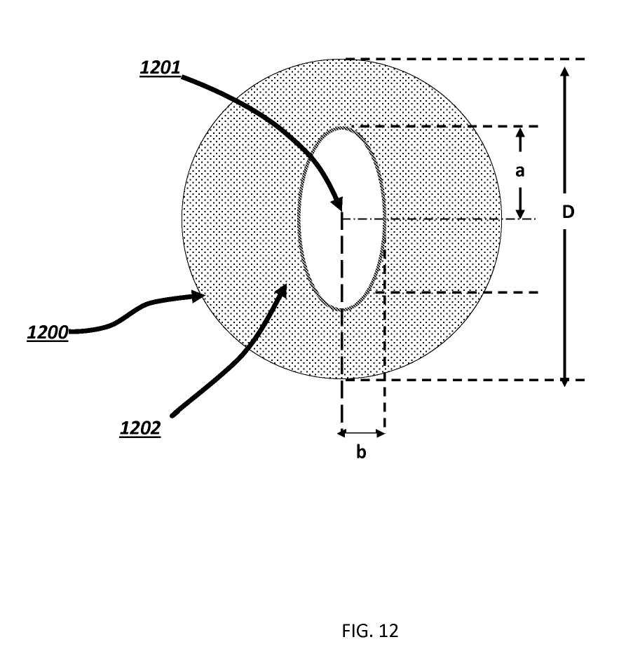

FIG. 12 is a cross-sectional view of optical fiber, 1200, having an elliptically-shaped core, 1201, having semi-major and semi-minor axes, a and b, respectively, surrounded by a dad region, 1202 having an outer diameter, D. Optical fibers having any regular or irregular shaped core can be fabricated using an appropriately dimensioned preform.

The compact Raman probe is designed to be coupled to any of a number of commercially available spectrometers, 790, of FIG. 7. Examples of such spectrometers include the QE65 Pro Scientific-grade Spectrometer and the USB2000+ Miniature Fiber Optic Spectrometer, both provided by Ocean Optics; the AvaSpec-HS2048XL provided by Avantes; the Exemplar and Exemplar Plus, both provided by B&W Tek; and the MINI-CCT+ provided by Horiba.

The elongated core optical fiber, 780, is chosen so that light emitted from the output end of the fiber slightly overfills the width of the spectrometer slit, 791, and has a substantially greater extent in the direction parallel to the slit edges.

Although the invention has been descried with regard to “a wavelength” emitted by the laser source or operated on by the Raman and Rayleigh scattering, it would be recognized that the term “a wavelength” is a term of art and refers to a wavelength or a band of wavelengths around a nominal desired wavelength.

In one aspect of the invention, the dichroic mirror reflects at least 90% of the incident light at the Raman excitation wavelength.

In another aspect of the invention, the dichroic mirror transmits no more than 1% of the incident light at the Raman excitation wavelength.

In an aspect of the invention, the filter transmits at least 80% of incident at longer wavelengths than the Raman excitation wavelength, said longer wavelengths being between approximately 5 cm⁻¹ and 4,000 cm⁻¹, as measured in wavenumbers, apart from the Raman excitation wavelength.

In an aspect of the invention, the filter transmits no more than 10⁻⁶ of incident light at the Raman excitation wavelength.

In an aspect of the invention, the dichroic mirror reflects light at the Raman excitation wavelength and transmits light at wavelengths shorter than the Raman excitation wavelength.

In an aspect of the invention, the dichroic mirror reflects at least 90% of incident light at the Raman excitation wavelength.

In an aspect of the invention, the dichroic mirror transmits no more than 1% of incident light at the Raman excitation wavelength.

In an aspect of the invention, the filter substantially transmits light at wavelengths shorter than said Raman excitation wavelength and substantially blocks light at the Raman excitation wavelength and longer wavelengths.

In an aspect of the invention, the filter transmits at least 80% of incident at shorter wavelengths than the Raman excitation wavelength, said shorter wavelengths being between approximately 5 cm⁻¹ and 4000 cm⁻¹, as measured in wavenumbers, apart from the Raman excitation wavelength.

In an aspect of the invention, the dichroic mirror transmits light at the Raman excitation wavelength and reflects light at wavelengths longer than the Raman excitation wavelength.

In an aspect of the invention, the dichroic mirror transmits at least 90% of incident light at the Raman excitation wavelength.

In an aspect of the invention, the dichroic mirror reflects no less than 98% of incident light at wavelengths longer than the Raman excitation wavelength.

In an aspect of the invention, the filter substantially transmits light at wavelengths longer than the Raman excitation wavelength and substantially blocks light at the Raman excitation wavelength and shorter wavelengths.

In an aspect of the invention, the filter transmits at least 80% of incident at longer wavelengths than the Raman excitation wavelength, said longer wavelengths being between approximately 5 cm⁻¹ and 4,000 cm⁻¹, as measured in wavenumbers, apart from said Raman excitation wavelength.

In an aspect of the invention, the dichroic mirror transmits light at the Raman excitation wavelength and reflects light at wavelengths shorter than the Raman excitation wavelength.

In an aspect of the invention, the filter substantially transmits light at wavelengths shorter than the Raman excitation wavelength and substantially blocks light at the Raman excitation wavelength and longer wavelengths.

In an aspect of the invention, the filter transmits at least 80% of incident at shorter wavelengths than the Raman excitation wavelength, said shorter wavelengths being between approximately 5 cm⁻¹ and 4,000 cm⁻¹, as measured in wavenumbers, apart from the Raman excitation wavelength.

The invention has been described with reference to specific embodiments. One of ordinary skill in the art, however, appreciates that various modifications and changes can be made without departing from the scope of the invention as set forth in the claims. Accordingly, the specification is to be regarded in an illustrative manner, rather than with a restrictive view, and all such modifications are intended to be included within the scope of the invention. Benefits, other advantages, and solutions to problems have been described above with regard to specific embodiments. The benefits, advantages, and solutions to problems, and any element(s) that may cause any benefits, advantages, or solutions to occur or become more pronounced, are not to be construed as a critical, required, or an essential feature or element of any or all of the claims.

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “of” refers to an inclusive “or” and not to an exclusive “or”. For example, a condition A or B is satisfied by any one of the following: A is true (or present) and B is false (or not present); A is false (or not present) and B is true (or present); and both A and B are true (or present).

The terms “a” or “an” as used herein are to describe elements and components of the invention. This is done for convenience to the reader and to provide a general sense of the invention. The use of these terms in the description herein should be read and understood to include one or at least one. In addition, the singular also includes the plural unless indicated to the contrary. For example, reference to a composition containing “a compound” includes one or more compounds. As used in this specification and the appended claims, the term “or” is generally employed in its sense including “and/or” unless the content clearly dictates otherwise.

All numeric values are herein assumed to be modified by the term “about,” whether or not explicitly indicated. The term “about” generally refers to a range of numbers that one of skill in the art would consider equivalent to the recited value (i.e., having the same function or result). In any instances, the terms “about” may include numbers that are rounded (or lowered) to the nearest significant figure.

It is expressly intended that all combinations of those elements that perform substantially the same function in substantially the same way to achieve the same results are within the scope of the invention. Substitutions of elements from one described embodiment to another are also fully intended and contemplated.

What is claimed is:

1. A Raman probe apparatus comprising:
a housing comprising:
a wavelength-stabilized laser outputting an output beam, said output beam comprising at least:
a selected Raman excitation wavelength;
a dichroic mirror directing said optical beam comprising said selected Raman excitation wavelength to a first optical path and said optical beam comprising wavelengths other that the Raman excitation wavelength to a second optical path;
focusing optics:
receiving said optical beam comprising said selected Raman excitation wavelength;
focusing said output beam onto a target of interest, said focused optical seam having a substantially elongated cross section; and
collecting and collimating wavelengths scattered from said target of interest;
a filter:
receiving said collected light scattered from said target of interest,
blocking said Raman excitation wavelength; and
transmitting wavelengths other than the Raman excitation wavelength;
an optical fiber comprising:
a clad region and a core region, said core region having an elongated cross-section, said elongated cross-section having a longer dimension and a shorter dimension;
coupling optics coupling a first end of said optical fiber, said coupling optics transmitting light transmitted through said filter to said first end of said optical fiber;
said optical fiber couplable, at a second end, to a spectrometer, wherein the shorter dimension of said elongated core section is aligned perpendicular to slit edges of said spectrometer and the longer dimension of said elongated core section is aligned parallel to said slit edges.

2. The apparatus of claim 1 wherein said dichroic mirror transmits said Raman excitation wavelength and reflects wavelengths other than said Raman excitation wavelength

3. The apparatus of claim 1 wherein said dichroic mirror reflects said Raman excitation wavelength and transmits wavelengths other than said Raman excitation wavelength.

4. The apparatus of claim 1 wherein said filter substantially transmits wavelengths longer than said Raman excitation wavelength and substantially blocks said Raman excitation wavelength and shorter wavelengths.

5. The apparatus of claim 1 wherein said filter substantially transmits wavelengths shorter than said Raman excitation wavelength and substantially blocks said Raman excitation wavelength and longer wavelengths.

6. The apparatus of claim 1, further comprising:
means for aligning the first end of said optical fiber, wherein said longer dimension of said optical fiber is aligned parallel to a longer axis of light transmitted through said filter to said first end of said optical fiber.

7. The apparatus of claim 6, wherein said means for aligning the first end comprises:
means for angularly aligning the longer dimension of said optical fiber to said longer axis of light transmitted through said filter.

8. The apparatus of claim 1 wherein said wavelength-stabilized laser is one of: an external cavity laser, a distributed feedback (DFB) laser and a distributed Bragg reflector (DBR) laser.

9. The apparatus of claim 1, wherein said wavelength-stabilized laser coupled to a non-linear optical element, said non-linear optical element generating a shorter wavelength laser light.

10. The apparatus of claim 1 wherein said filter is one of: a dichroic filter, a volume holographic grating filter, and a fiber Bragg grating filter

11. The apparatus of claim 1 wherein said optical fiber is attached to one of: an interior of said housing and an exterior of said housing.

12. The apparatus of claim 1 wherein the wavelength-stabilized laser is one of: a multi-spatial mode laser and a single-spatial mode laser.

13. A Raman probe comprising:
a laser generating at least a select Raman wavelength:
a mirror:
receiving said select Raman wavelength on a front surface;
transmitting said select Raman wavelength toward a target object;
receiving light scattered by said target object on a back surface;
a filter:
receiving from said mirror said light scattered by said target object;
filtering at least said select Raman wavelength from said light scattered by said target object;
an optical fiber comprising an elongated core receiving said filtered light from said filter; and
adjustment means for adjusting a longer dimension of said elongated core to a longer dimension of said filtered light.

14. The Raman probe of claim 13, wherein said adjustment means orients said optical fiber core with respect to said received filtered light in at least one of: a vertical, a horizontal and an angular direction.

15. The Raman probe of claim 13 further comprising:
a first focusing means for focusing said selected Raman wavelength onto said target object; and
a second focusing means for focusing said filtered light from said filter onto said optical fiber.

16. The Raman probe of claim 13, wherein said elongate core of said optic fiber is one a: a rectangle and an ellipse.

17. A Raman probe comprising:
a laser generating an laser beam, said laser beam comprising at least a Raman wavelength;
a mirror:
receiving said laser beam;
reflecting said at least a Raman wavelength;
a focus means for focusing said at least a Raman wavelength onto a target object and for collecting light scattered by said target object;
a filter filtering said light scattered by said target object, said filter removing at least said Raman wavelength from said light scattered by said target object; and
an optic fiber comprising an elongated core receiving said filtered light from said filter; and
adjustment means for:
securing said optical fiber with respect to said filter; and
adjusting a longer dimension of said elongated core to a longer dimension of said filtered light.

18. The Raman probe of claim 17 wherein said filter is at least one of: a notch filter; a low pass filter and a high pass filter.

19. The Raman probe of claim 17, wherein said mirror is at least one of: a notch filter; a low pass filter and a high pass filter.

20. The Raman probe of claim 17, wherein said adjustment means orients said optical fiber core with respect to said received filtered light in at least one of: a vertical, a horizontal and an angular direction.
